(19) United States
(12) Patent Application Publication
(10) Pub. No.: US 2011/0161252 A1
(43) Pub. Date: Jun. 30, 2011

(54) STATIC MEDIA DISK METHOD AND APPARATUS

(76) Inventor: EDWARD FOSTER CARR, ANACORTES, WA (US)

(21) Appl. No.: 12/611,854

(22) Filed: Nov. 3, 2009

Related U.S. Application Data
(60) Provisional application No. 61/110,969, filed on Nov. 3, 2008.

(51) Int. Cl. G06Q 90/00; B32B 38/14

(52) U.S. Cl. 705/500; 156/277; 156/384

(57) ABSTRACT

A system and method for producing a static media disk is provided. The method includes designing a media graphic utilizing a computer graphics program. Next the media graphic is placed into a template within the computer graphics program. A media layer sheet is prepared for the installation of the media graphic onto the media layer sheet. The media layer is formed when the media graphic is installed on to the media layer sheet. The media layer has a first media surface and an opposing adhesive surface. The adhesive surface is for securing the media layer to the first surface of a core medium or media disc. The core medium has a material property and a shape property. The shape property substantially matches the media layer itself. The core medium has a first surface, second surface and thickness. The static media disc is then formed when the media layer is installed onto the core medium.

### RELATED APPLICATIONS

This application claims priority benefit of U.S. Ser. No. 61/110969, filed Nov. 3, 2008.

### BACKGROUND

U.S. Pat. No. 668,567 discloses a disc or double stopple for bottles, where the discs seal milk bottles and the like, and one object is to provide the discs with a curvilinear unit strip so that when they are closed, handles are formed for removing said discs from the bottles after they have been closed together and inserted into the neck of the bottle, thus sealing the contents therein. Secondly a further object as seen in column 1 around line 25, is to utilize the surface of the stopper as an advertising medium, this advertising means being equally applicable to one disc as to twin discs or double stopples.

U.S. Pat. No. 925,082 discloses a measuring instrument which provides a “novel” way for measuring linear distances by utilizing as seen in column 1 around line 18, a flat disc of certain circumference, say 6 inches, . . . placed with graduations in numerals on one or both flat sides of the disc adjacent to the edge indicating inches and subdivisions of inches. In column 2 around line 92, the flat sides of the disc present a surface which may be readily printed, stamped, or engraved and its purpose is to utilize the surface to bear advertising matter as the device can be made so cheaply that it can be given away as an advertising medium, the advertising secured being sufficient remuneration for the cost of manufacture.

U.S. Pat. No. 1,556,515 discloses a coupon whereby any particular organization, such as an electric light company, can stimulate the attendance of the public on their own stores and at the same time direct attention of the public to other cooperating merchants in any given locality. Further attention may be called to advertising matter disposed on the coupons. As seen in column 1 around line 38, in general, it requires that one company . . . , send out with its monthly light bills with these coupons or tokens in the form of portions folded together and separated only by perforating a line between them, whereby they can be torn apart. The outer surface of one portion of coupon, when the device is folded together, represents or calls attention to the fact that this portion of the token is given in exchange for other coupons at certain stores owned by the electric light company. Furthermore, as seen in column 2 around line 55, “the back of the token also contains some advertising matter and the statement that this token can be exchanged at other stores not necessarily connected to the first one associates therewith in a sufficiently definite way the consumers of the first store will proceed to the second store...”

U.S. Pat. No. 3,143,998 discloses a bookmark where as seen in column 1 around line 30, “the page marker disc is connected with a clip member by means of a length of cord or other flexible connector. A central space is provided in the page marker disc whereon may be provided advertising indicia etc.” Furthermore in column 2 around line 18, “the page marker disc 18 is connected with the clip member 11 . . . . A central space is provided on the page marker disc whereon may be marked indicia for advertising purposes.”

U.S. Pat. No. 6,372,320 discloses a disc like plastic body with inlay portion, where the inlay portion consists of at least one composite filler body holding the inlay portion between itself. A visually pleasing plastic body which is easy and cheap to make is provided... by the fact that the filler body is encompassed by two lid like films, one film after the fashion of a cup surrounding the filler body on one side and the other, opposite film after the fashion of a lid being applied to the opposite side of the filler body. As seen in column 1 around line 7, “the present subject of invention are for example casino chips, parking tokens, shopping tokens, value tokens, amusement arcade tokens, personalization tokens, for example as a pass card.”

U.S. Pat. No. 7,437,840 discloses a memorabilia apparatus where indicia are imprinted on a medallion using conventional minting technology.

In the summary of the invention section in column 1 around line 37, “the invention comprises a hockey puck or a model of a tire. A cavity appears in the hockey puck or model of tire and a medallion composed of a precious metal or other material is inserted into the cavity. Indicia appear on the medallion embossed by conventional minting or coining technology. The indicia may comprise a team or a league logo, the image of a player, driver, automobile, trophy, stadium, racetrack, a motto, or any other indicia. The medallion is removable from the cavity in the puck or model of the tire and one medallion may be changed for another by the collector. The medallion may have two sides and indicia may appear on both sides.”

Furthermore in column 3 around line 9 “the medallion may be composed of a precious metal, but any material for medallion is contemplated by the invention. For example, medallion may be composed of wood, ceramic, synthetic plastics, or any other material. While embossing using minting technology is preferred, invention contemplates any method for imparting indicia to the medallion.”

US 2003-0177674 discloses a method and apparatus for advertising and promoting having a peel-away label. The system uses a token with a complimentary coupon for distribution to the patrons of different entities and events. A small and relatively inexpensive complementary item may be mass-produced for mass distribution to patrons or prospective patrons or different entities at events. As seen in the summary of the invention section, paragraph 5, “the comp items may serve as an advertising or promotional tool. Each comp item however, will include a removable comp coupon, each will indicate a more valuable gift than the comp item itself. The comp item includes identifying marks and logos so that the patron or prospective patron will have an immediate remembrance or indication of the proprietor or comp item.” In paragraph 6, “the present invention is a collectible chip or coin...” Further in the same paragraph “also printed on the collectible chip or coin, is a name, location and other identifying features such as a logo, to indicate where the collectible chip or coin originated.”

US 2004-0050724 discloses a promotional system, where a carrier of information is releasably affixed to a container, such as a beverage can. The carrier of information may be a small diameter compact disc, token, et cetera. As seen in paragraph 11, “preferably the carrier is a compact disc or a token bearing promotional information on at least one side. The token is preferably disc shaped, but may also be of other shapes.” As seen in paragraph 73, “as used herein, token includes anything that bears promotional information and it includes such things as tokens, tickets, lottery and scratch-off lottery tickets, gaming cards, trading cards, coupons, game connectors . . . , brochures with text or photographs or images contained thereon, stickers, labels and so forth. The tokens may be constructed of any suitable materials, such as paper, cardboard, plastic, metal films and plates, and the like, including combinations of these.” In paragraph 74, the application discusses the interior side of the token which “may have promotional material that has an opaque covering layer that can only be discerned after removing the token from the container, and scratching the covering layer away.”

US 2004-0254025 discloses advertising and item identification apparatus and method where a two-piece marker facilitates placing advertising, recognition or identification information on an item having a marker receiver. It appears that the marker has an information surface, with an applied adhesive, a base unit, and a raised edge with the base unit also having an applied adhesive. In the summary of the invention section, paragraph 9, “the marker allows a marketer to advertise a product or service to a consumer. The marker will be a two-piece assembly wherein the first piece, the base unit, affixes to the item, and is designed to include an approximately ⅜″ information bezel which can be engraved or imprinted with advertising or recognition information. The second piece, the insert unit, affixes to the base unit and is approximately the size, shape and weight of a coin, and is designed with the flat circular or polygonal information surface, which can be engraved or imprinted with personal identification, as well as with additional advertising or recognition information.”

US 2005-0251447 discloses a promotional method involving the use of tokens, or the method uses a commercial activity which involves identifying customers to be attracted to the commercial activity, distributing at least one token to each of the identified customers, each of the distributed tokens having a true cash value within the situs where the commercial activity takes place in allowing the identified customers to which the tokens are distributed to participate in the commercial activity within the situs. The tokens can also be provided with serialized data that can be collected and recorded when the tokens are distributed and collected using imaging technology. As seen in paragraph 33, “according to one aspect of the present invention, the serialized tokens are used in a business method to promote aiding potential and/or repeat customers to engage in gaming activities in a casino.” Furthermore in paragraph 34, “the tokens are the equivalent of cash because they have a face value and are the actual cash.

US 2007-0208622 discloses a promotional method involving the use of tokens, which involves identifying consumers to be attracted to participate in commercial activity within a municipality, distributing at least one token to each of the identified customers, allowing the consumers to exchange the tokens for discount cards that have a predetermined dollar discount value for commercial activity within a municipality; allowing the consumers to purchase goods and/or services for merchants within the municipality; and having the merchants from which goods and or services are purchased discount the purchase price and deduct the discounted amount from the predetermined dollar discount value of the consumer's discount

### BRIEF DESCRIPTION OF THE DRAWINGS

FIG. 1 is a schematic flowchart of the static media disc utilization method;

FIG. 2 is a schematic flowchart of the acquire disc process;

FIG. 3 is a schematic flowchart of the prepare layers process;

FIG. 4 is a schematic flowchart of the utilize disc process;

FIG. 5 is an elevational view of a first embodiment of the disk;

FIG. 6 is a top plan view of a first embodiment of the disc;

FIG. 7 is a bottom plan view of a first embodiment of the disc.

### DESCRIPTION OF THE PREFERRED EMBODIMENTS

Generally speaking, a static media production method is used to design, place, prepare, print, acquire, and install the designs onto the discs for the production of a static media disc used for promotional activities, memorabilia activities, trading card activities, game activities, or combinations of the above in either a noncommercial setting or commercial setting.

The initial designs may come from a client or be designed in-house by the production company, and the production company will design the media graphic utilizing a computer graphics program. The program itself has a template which has been preconfigured for large-scale production of the graphics onto the media layer sheet. The media graphics are recorded or installed onto the media graphic sheet. A core medium or media disc is chosen to receive a media layer, which has the media graphic, based on the predetermined end user requirements on one or both of the faces of the core medium. This results in the final production of the static media disc.

There are many reasons for use of the static media disk. These include marketing and advertising uses for attracting customers back to a store, attracting customers into the store for first use, promoting products and/or services through cross promotional techniques, utilizing the static media disk in a collectible scenario for example in the use of trading cards, sports memorabilia, and situations where autographs and other types of highly individualized and memorialized moments develop value as interest and time progress. Also of value is the use of the static media disk in business-to-business relations similar to the use of content cards or business cards for transferring information and making a business impression.

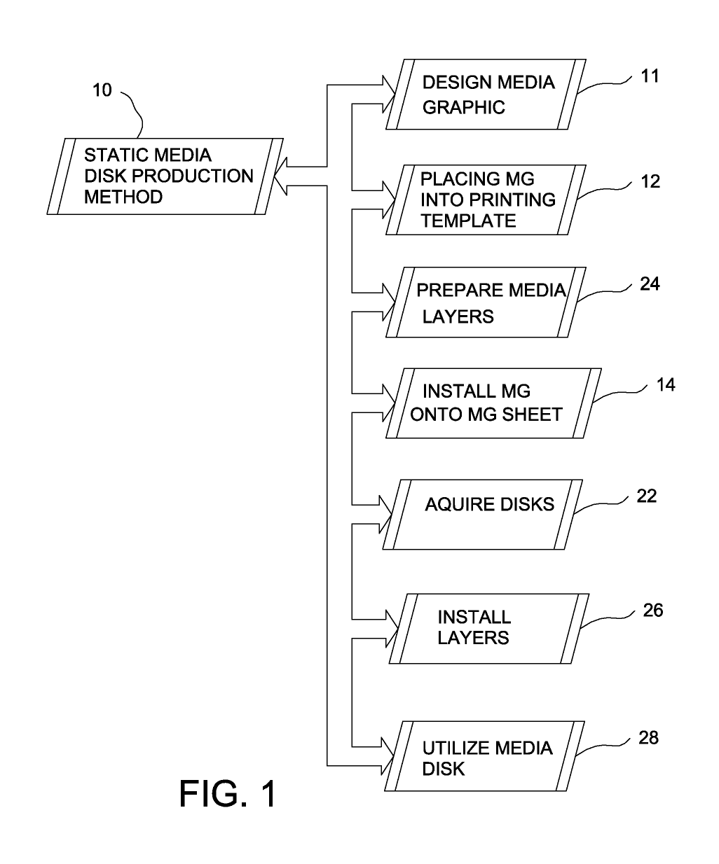

In order to accomplish some of these ends, a method of producing a static media disk has been developed. In general terms the static media disc production method 10 as seen in FIG. 1 includes the following general steps: designing the media graphic at step 11, placing the media graphic into a printing template at step 12, preparing the media layer sheet at step 24, installing the media graphic onto the media layer sheet at step 14, acquiring a core medium or core disc at step 22, installing the media layers at step 26, and utilizing the media disc at step 28.

Referring to step 11, the step of designing the media graphic includes using a combination of an Adobe Photoshop application and Adobe Acrobat Illustrator application which produces an Adobe Illustrator file. The Adobe Illustrator file is configured within a printing template within which the designer can arrange the media graphic onto the printing template for later installation of the graphic onto the media layer sheet.

Because the media disc will have two surfaces or faces as discussed below, there may be a requirement for a first surface design and a second surface design. If this is the case, a second media graphic can also be produced for, say for example, on the second face of the media disc. The second media graphic can also be arranged for production into the same template as the original or first media graphic.

During the design step, the media graphic may be designed utilizing text, clip art, photo images, graphic designs, barcodes, logos, or artwork. For example, the design may be taken from a business card with a logo, or an idea itself may be proposed to the production company, and the business card or logo is scanned into Adobe Photoshop for cleaning up the graphics etc., and then various additional artwork is placed onto the media graphic for production purposes.

When a media graphic is designed, the production company will produce a certain number of the media graphics for installation onto the core mediums. For example, a first large group or first group of first media graphics, say for example, on the front face of the disc, may be designed for installation onto the front face or first media surface of a first group of core mediums or in other words media discs. The media graphics are installed onto the media layer sheet which has a prearranged number of media layers for receiving at least the amount of template fields in the graphics program. Once the media graphics are installed onto the media layers, the media layers can be taken off the media layer sheet and arranged onto the media discs or first group of core mediums.

The second media graphic can also be placed onto the printing template along with the first media graphic. The media layer sheet is prepared and the second media graphic along with first media graphic may be installed onto the media layer sheet. Therefore the first media layer and the second media layer are produced at the same time. In an alternative embodiment, separate runs for the first media layer sheet and the second media layer sheet can be made depending upon the production run.

It should be noted that the media layer sheet which provides the first media layer and the second media layer each have a first media surface and opposing adhesive surface. The first media surface receives the media graphic material, and the opposing adhesive surface is for securing the media layer to the first or second surface of the core medium or, in other words, the first or second surface of the media disc.

After the first media layer is installed, the second media layer may be installed by removing it from the media layer sheet and aligning the second media layer with the second surface of the core medium or media disc.

In order to utilize the static media disc, the core medium or media disc must be acquired or chosen.

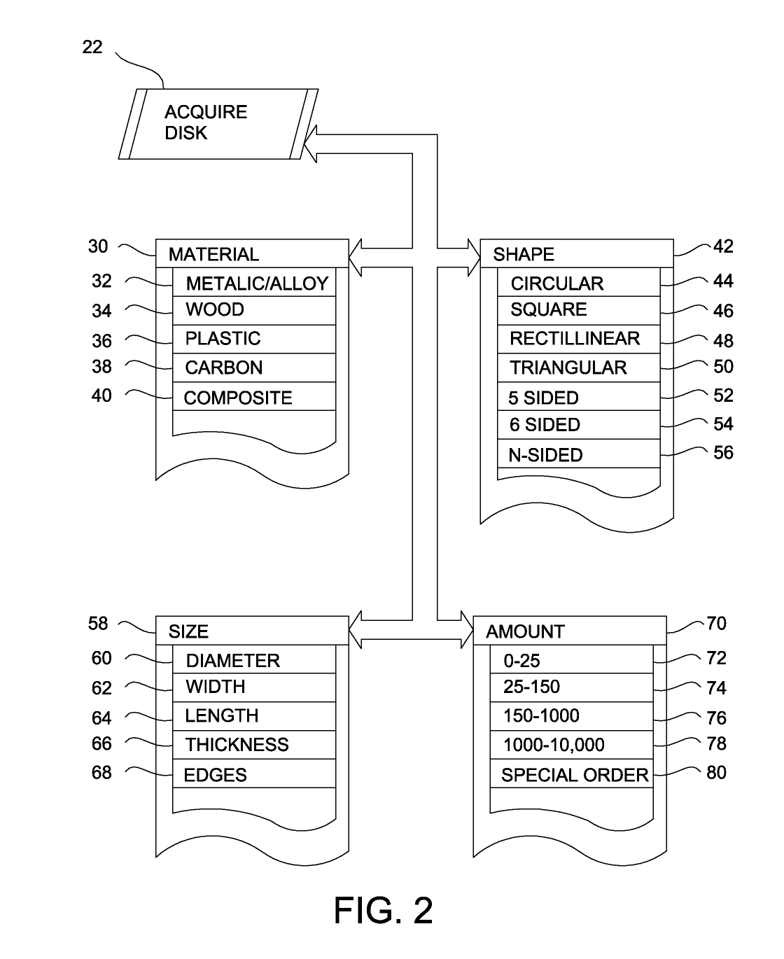

In order to acquire the static media disk at step 22, and referring to FIG. 2, the user must first choose the material at step 30. As previously discussed, the user can choose from metallic/alloy material at step 32, a wood material at step 34, plastic material step 36, carbon material at step 38, or composite materials at step 40. Once the particular material is chosen, the user must then determine the particular shape at step 42. Various shapes are provided including a circular shape at step 44, square shape at step 46, rectilinear shape at step 48, triangular shape at step 50, a 5 sided shape at step 52, a 6 sided shape at step 54 and a variable n-sided shape at step 56 depending on upon the customization purposes for the end user.

With the material and shape determined, the user can then choose the size at step 58. The size may be determined by the shape as previously chosen but likely will have the following parameters which include a diameter at step 60, a width at step 62, a length at step 64, thickness at step 66, and various edge designs at step 68. During the customization and acquisition of the static media disk, the number of disks required may also be chosen. Therefore the amount of discs at step 70 may be determined. This may include a 0 to 25 discs at step 72, 25 to 150 discs at step 74, 15 to 1000 discs at step 76, and 1000 to 10,000 discs at step 78. In addition to the predetermined quantities, a special order at step 80 may be provided.

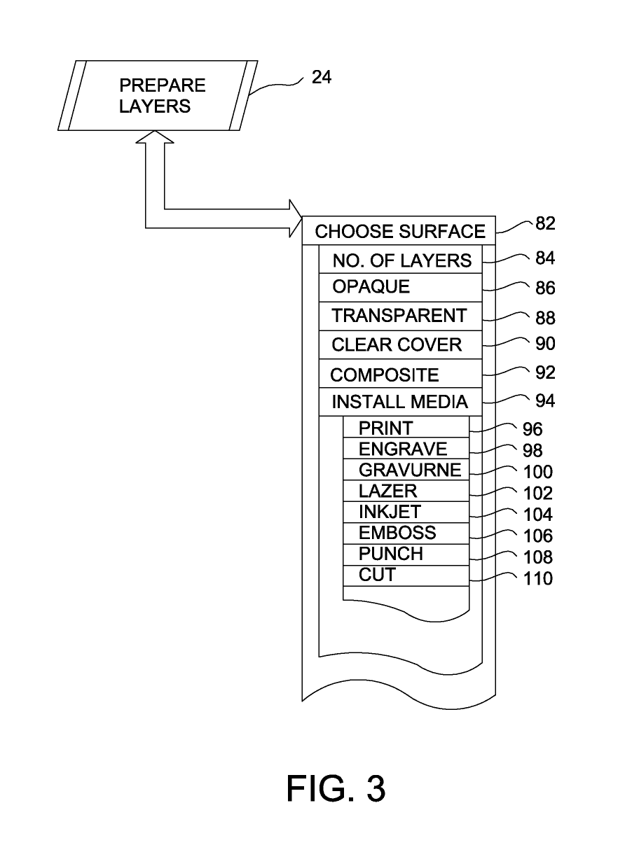

Once the disk has been acquired, the next step in the static media disk production method includes preparing the layers at step 24 as seen in FIG. 3. Here the user must choose the surface onto within which to install the particular layer at step 82. Once the surface is chosen, the number of layers must be chosen at step 84. The number of layers may include the first inner layer 204 the first outer layer 202, the second inner layer 212, and the second outer layer 214. An optional third outer layer which may be used as a semi-permanent removable cover for various types of promotional activities may be provided. Each of the layers previously chosen at step 84 must be provided as either an opaque layer at step 86 or a transparent layer at step 88. The opaque layer at step 86 is an inner layer having in one embodiment a white photo gloss archival quality acid-free media image retention characteristic. The transparent layer at step 88 in one embodiment may be the clear gloss label materials previously discussed. In addition, a composite layer at step 92 may be provided which incorporates both transparent and opaque properties.

Once the particular layer is chosen and the particular characteristic materials are chosen, the media must be installed onto the media graphic sheet at step 94. Here the media can be printed on at step 96, engraved at step 98, laid on in a gravune process at step 100, printed through the use of the LaserJet at step 102, printed through the use of an inkjet step 104, embossed at step 106, punched at step 108, or cut at step 110.

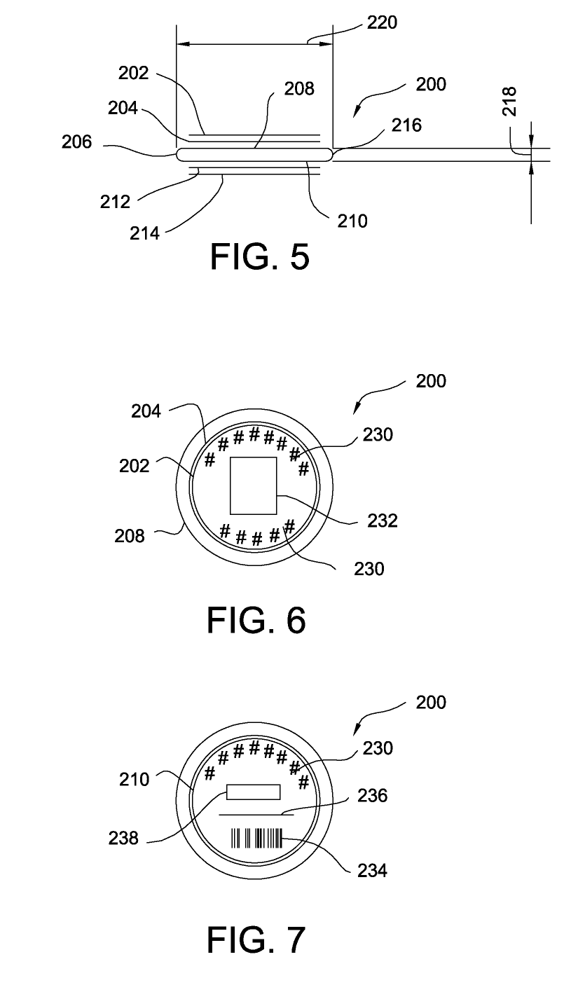

With the layers prepared as seen previously in FIG. 1, the layers must now be installed onto the media disk at step 26. The layers must be installed either by hand or by machine and placed on the respective first surface 208 as seen in FIG. 5 or second surface 210 as predetermined by the layer preparation process 24.

With the layers installed on the core stratum or core medium 206 of the static media disk 200, the media disk is ready to be utilized at step 28.

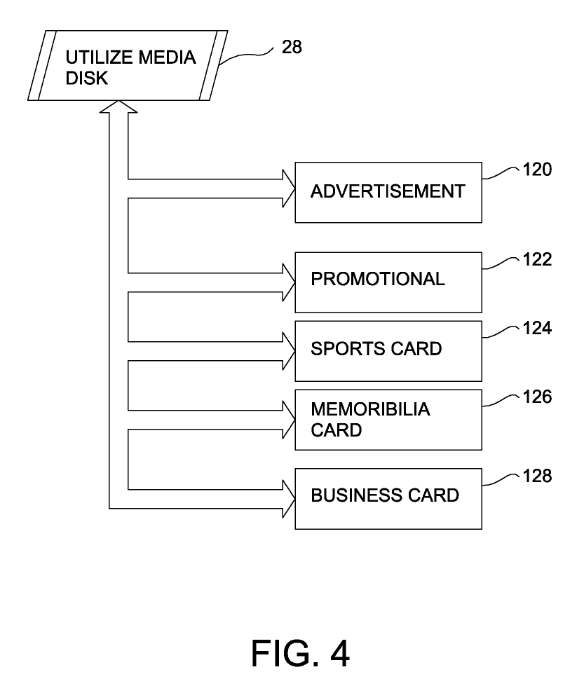

Depending on the previous preparation and customization, the media disk may be utilized in an advertisement process at step 120 as seen in FIG. 4. The advertisement process includes placing a company logo or company name on the first surface 208 of the static media disk and affiliating the design with either a seasonal campaign, a patriotic campaign, a business related promotional campaign, or other type of goodwill campaign. In addition the media disk can be utilized through promotional process at step 122 which may include promoting of products and services through use of discounted value for a push or pull type customer draw or attraction. The static media disk may have on its first or second surface a gift card amount, a percentage discount off amount, a monetary amount off redeemable if returned to the business, et cetera.

The media disk may be utilized as a sports memento at step 124 wherein the athlete or contestant is placed in as seen in FIG. 6, the media image location 232 and the static media disk is customizable for autographs on the second surface in the field memo 236.

The second surface 210 as previously discussed may have the second outer layer 214 uninstalled to leave a blank second inner layer 212 ready for user customizable markings for leaving messages and the like. In other words, this particular use of the static media disk can be provided at step 120 as a memorialized card or disk.

The static media disk can be utilized as a business card at step 128 where the individual may customize the front or first surface 208 with a particular media image and media text which relates to the individuals business and contact information. The second surface 210 can be either left blank or customized with additional information as needed.

A discussion of the apparatus or physical disk components will now be provided as seen in FIGS. 5, 6, and 7. Referring briefly now to FIG. 5, the static media disk 200 in one embodiment is a cylindrical disk which has a core medium 206 and multiple first and second layers which will be discussed. The first and second layers hold the media and are installed onto the first surface 208 of the core medium 206 in the second surface 210 of core medium. In this particular embodiment, the disk 200 has a circular diameter distance 220 which ranges from approximately about 3 inches in diameter to approximately about three quarters of an inch in diameter depending upon the desired size. In correlation, the disc thickness 218 ranges from approximately one quarter of an inch in thickness to approximately 1/16 of an inch in thickness depending again on the size and structural properties of the core medium 206.

The core medium 206 may be constructed of various materials which may range from metallic, to wood, plastic, carbon, or to a form of composite material which may include one or more of the previously listed materials. In addition, various petroleum-based galvanized rubber or a natural rubber material may be used.

As previously mentioned, the first set of layers and the second set of layers are each installed onto the first surface 208 and second surface 210 respectively. A brief discussion of the layers will now be provided. The first layers include a first inner layer 204 and the first outer layer 202. The first inner layer in this particular embodiment is a white photo gloss labeling material which has archival quality and may be used in an inkjet, laser or color laser printer. The acid-free photo gloss sheets have approximately a total thickness of seven mils and a brightness rating of 92. In an alternative embodiment the first surface only includes the first inner layer.

Multiple types of sheets may be used. Each of the first inner layer sheet types have a media surface for installation of the media and an adhesive surface for securing the first inner layer to the first surface of the core medium.

While the above embodiment utilized a white photo gloss labeling material, an alternative embodiment may include a soft calendared, 3 ml, PVC film, in either a white, gloss, or matte finish such as the Orajet series 3640 media. Sheets may also feature resin base coating which locks ink immediately and provides a high level of resistance against wear and tear even when moisture's present. While in one embodiment the white photo gloss label material is used, other printable, engrave-able, emboss-able, or gravure printing materials may be used. This particular embodiment of material would be applicable for use in a single inner layer application with no outer layer.

The first inner layer 204 receives the media image and or media text also referred to as media information and to prevent against deterioration of the media information, a first outer layer 202 may be provided. The first outer layer is composed of a clear gloss label material which serves the main purpose of protecting the media layer. The first outer layer is made of a transparent polyester material or laminate, and has on one face a permanent adhesive. In one embodiment, the first outer layer 202 is provided as a completely transparent material. In a second embodiment, this particular material may have opaque portions placed on the inner surface of the first outer layer to prevent display of images or information behind the opaque portion of the layer. In another embodiment, the transparent layer maybe printed on for additional media information.

The discussion of the second set of layers will now be provided. The second set of layers includes a second inner layer 212 and a second outer layer 214. The second inner layer 212 is composed of the same material as the first inner layer 204. The second inner layer 212 also has an adhesive material on its inner surface which enables it to be fixed to the second surface 210 of the static media disk 200. The second outer layer 214 may optionally be utilized for preservation of a media image 232 or the second outer layer may not be utilized thus enabling the user to mark directly on the back of the static media disk 200 or the second surface 210 for personalized customization of the disk such as for use during an autograph session or some form of memento activity to be discussed further below.

The static media disk 200 as seen in FIG. 5 has a perimeter edge 216 which may be a rounded bevel edge, a chamfered edge, or a straight vertical edge depending upon the desired ornamental customization.

Referring to FIG. 6, a brief discussion of embodiments of the static media disk 200 displaying media information will now be provided. The media information being displayed includes media text 230 the media image 232 where the media texts 230 and media image 232 are installed on the first inner layer 204 and portions or all of the media text are readable through the first outer layer 202. The media image 232 may be a photograph, a depiction of a product or service, a logo, an artistic rendering, or some promotional image. The location of the media text 230 is shown here in one embodiment and the media text may be aligned circumferentially, linear, incorporated with the media image, or some other configuration depending on the design.

Referring to FIG. 7, a brief discussion of the second surface 210 will now be provided. The second surface 210 may also incorporate media text 230 as well as a media image 232. The present embodiment has a memo field 236 enabling the user to mark on the field a customized hand installed marking for unique customization of a particular disk. In addition, an optional barcode 234 may be utilized when they media discs are provided as redeemable coupons or some other promotional activity affiliated with the sale of a product or service. Not shown, but also included is the use of radio frequency ID tags either in a passive form or active form.

1. A static media disc production method comprising:
a. designing a media graphic utilizing a computer graphics program;
b. placing said media graphic into a printing template resident in said computer graphics program;
c. preparing a media layer sheet comprising a plurality of blank sheet layers, said media layer sheet configured to receive installation of said media graphic resident within said printing template onto said media layer sheet;
d. installing said media graphic onto said media layer sheet to form a media layer comprising a first media surface and an opposing adhesive surface for securing the media layer to a core medium first surface;
e. acquiring a core medium by choosing a material, choosing a shape, and choosing a size to substantially match the media layer, said core medium comprising said first surface, a second surface, and a thickness;
f. installing said media layer by removing said media layer from said media layer sheet and aligning said adhesive surface onto said first surface of said core medium, said media layer displaying said media graphic on said core medium and resulting in the production of said media disk.

2. The method according to claim 1 wherein said method further comprises: designing said media graphic utilizing a combination of Adobe Photoshop and Adobe Acrobat Illustrator; producing an Adobe Illustrator file comprising said printing template to hold said media graphic.

3. The method according to claim 1 wherein said method further comprises: designing said media graphic by utilizing text, clipart, photo images, graphic designs, barcodes, logos, artwork.

4. The method according to claim 1 wherein said method further comprises: designing a second media graphic utilizing said computer graphics program, said second media graphic configured for a second media layer to be arranged on said second surface of said core medium.

5. The method according to claim 1 wherein said method further comprises: preparing said printing template with a first group of first media graphics each configured for a first media surface on a first group of core mediums; installing said first group of media graphics resident within said printing template onto said media layer sheet to form a first group of media layers; installing said first group of media layers onto said first group of core mediums.

6. The method according to claim 1 wherein said method further comprises: choosing a first outer layer comprised of a transparent material for protecting said media layer on said core medium.

7. The method according to claim 4 wherein said method further comprises:
a. placing said second media graphic into said printing template resident in said computer graphics program along with said media graphic;
b. preparing said media layer sheet for installation of said media graphic and said second media graphic resident within said printing template onto said media layer sheet;
c. installing said second media graphic onto said media layer sheet along with said media graphic to form a media layer for said media graphic, and a second media layer for said second media graphic, said second media layer comprising a second media surface and an opposing second adhesive surface for securing the second media layer to said second surface of said core medium;
d. installing said second media layer by removing said second media layer from said media layer sheet and aligning said second adhesive surface onto said second surface of said core medium, said second media layer displaying said second media graphic on said core medium and resulting in the production of said media disk with and resulting in the production of said static media disk with said media layer and said second media layer.

8. The method according to claim 1 wherein said method further comprises: acquiring said core medium by choosing said material comprising at least one from a group of materials comprising: a metallic/alloy material; a wood material; a plastic material; a carbon material; a composite material.

9. The method according to claim 8 wherein said method further comprises: acquiring said core medium by choosing said shape comprising at least one from a group of shapes comprising: a circular shape; a square shape; a rectilinear shape; a triangular shape; a pentagon shape; a hexagon shape; a multi-sited shape.

10. The method according to claim 9 wherein said method further comprises: acquiring said core medium by choosing said size comprising a diameter ranging from at least about ¾″ to at most about 3″; a thickness ranging from at least about 1/16″ to at most about ¼″.

11. The method according to claim 9 wherein said method further comprises: acquiring said core medium by choosing said shape comprising an edge finish comprising at least one of a group of edge finishes comprising: a straight edge, a chamfered edge, a beveled edge.

12. The method according to the claim 1 wherein said method further comprises: installing said media layer into a surface recess in said first surface of said core medium.

13. The method according to claim 1 wherein said method further comprises: acquiring said core medium by choosing an amount of core mediums for production ranging from about 1 to about 10,000.

14. The method according to claim 1 wherein said method further comprises: installing said media graphic onto said media layer sheet to form said media layer by: printing said media graphic from said computer graphics program to a printer utilizing an ink jet printing process.

15. The method according to claim 1 wherein said method further comprises: installing said media graphic onto said media layer sheet to form said media layer by: printing said media graphic from said computer graphics program to a printer utilizing a laser printing process.

16. The method according to claim 1 wherein said printer utilizes at least one of the following: a gravure process, an engraving process, an embossing process, a cutting process.

17. The method according to claim 1 wherein said core medium is utilized for at least one of a useful group processes comprising: an advertising process; a promotional process; a sports memorabilia process; a memorabilia card; a business card; a redeemable coupon.

18. The method according to claim 1 wherein said method further comprises: said printing template comprising a first group of printing template fields for receipt of said media graphic; said media layer sheet further comprising a first group of blank sheet layers equal to or greater than said first group of printing template fields.

19. A method of utilizing a static media disc for promotional purposes comprising:
a. obtaining a core medium comprising a first surface, second surface and a thickness, and further comprising a material defining said first surface, second surface, and thickness;
b. placing a first inner-media layer onto said first surface of said core medium, said first inner-media layer comprising a first media surface for carrying a first media graphic, an opposing first adhesive surface for securing said first inner-media layer to said first surface of said core medium;
c. securing a first transparent outer layer over said first inner-media layer for protecting said first inner-media layer on said core medium;
d. placing a second inner-media layer onto said second surface of said core medium, said second inner-media layer comprising a second media surface for carrying a second media graphic, an opposing second adhesive surface for securing said second media layer to said second surface of said core medium resulting in said static media disc;
e. providing said static media disc to a company; said company providing said static media disc to a customer; said customer returning to said company to redeem said static media disc for a transaction comprising: a discount, a monetary value back, a free item.

20. A production system for producing a static media disc comprising:
a. means for designing a media graphic utilizing a computer graphics program;
b. means for placing said media graphic into a printing template resident in said computer graphics program;
c. means for preparing a media layer sheet for installation of said media graphic resident within said printing template onto said media layer sheet;
d. means for installing said media graphic onto said media layer sheet to form a media layer comprising a first media surface and an opposing adhesive surface for securing the media layer to a first surface of a core medium;
e. means for acquiring a core medium by choosing a material, choosing a shape, and choosing a size to substantially match the media layer, said core medium comprising said first surface, a second surface, and a thickness;
f. means for installing said media layer by removing said media layer from said media layer sheet and aligning said adhesive surface onto said first surface of said core medium, said media layer displaying said media graphic on said core medium.
